(19) United States
(12) Patent Application Publication
(10) Pub. No.: US 2011/0306734 A1
(43) Pub. Date: Dec. 15, 2011

(54) THERMOPLASTICALLY PROCESSABLE POLYURETHANES BASED ON SUCCINIC ACID PROPIONATES

(75) Inventors: Wolfgang Bräuer, Leverkusen (DE); Yi Shen, Shanghai (CN); Wolfgang Kaufhold, Koln (DE); Hartmut Nefzger, Pulheim (DE); Henricus Peerlings, Solingen (DE)

(73) Assignee: Bayer MaterialScience AG, Leverkusen (DE)

(21) Appl. No.: 13/116,099

(22) Filed: May 26, 2011

(30) Foreign Application Priority Data
Jun. 2, 2010 (DE) 102010022464.2

(51) Int. Cl. C08G 18/66; C08G 18/76; C08G 18/75

(52) U.S. Cl. 525/440.08; 525/440.01; 525/440.12

(57) ABSTRACT

The present invention relates to a thermoplastically processable polyurethane elastomer having a hardness of 50 Shore A to 70 Shore D (ISO 868), which are obtained from reacting components comprising a) one or more linear polyester diols having a functionality from 1.8 to 2.2, wherein the one or more linear polyester diols comprise succinic acid 1,3-propionate and have an average molecular weight from 1,950 to 4,000 g/mol. b) one or more organic diisocyanates, and c) one or more diols having a molecular weight from 60 to 350 g/mol, wherein the components have a molar NCO:OH ratio of from 0.9:1 to 1.1:1.

### CROSS REFERENCE TO RELATED APPLICATIONS

This application claims benefit to German Patent Application No. 10 2010 022 464.2, filed Jun. 2, 2010, which is incorporated herein by reference in its entirety for all useful purposes.

### BACKGROUND OF THE INVENTION

The present invention relates to thermoplastically processable polyurethanes based on succinic acid propionates.

Thermoplastic polyurethane elastomers (TPUs) have been known for a long time. They are of industrial importance due to the combination of high performance mechanical properties with the known advantages of inexpensive thermoplastic processability. A wide range of variation of the mechanical properties can be achieved by the use of different chemical builder components. An overview of TPUs, their properties and uses is given e.g. in Kunststoffe 68 (1978), pages 819 to 825 or Kautschuk, Gummi, Kunststoffe 35 (1982), pages 568 to 584.

TPUs are built up from linear polyols, usually polyester or polyether polyols, organic diisocyanates and short-chain diols (chain lengtheners). Catalysts can additionally be added to accelerate the formation reaction. To establish the properties, the builder components can be varied within relatively wide molar ratios. Molar ratios of polyols to chain lengtheners of from 1:1 to 1:12 have proved appropriate. This results in products in the range of from 50 Shore A to 75 Shore D.

The TPUs can be prepared continuously or discontinuously. The best known industrial preparation processes are the belt process (GB 1057018 A) and the extruder process (DE 1964834 A and DE 2059570 A).

A diversity of combinations of properties can be established in a controlled manner via the polyols, good mechanical values of course being particularly important for elastomers. The use of polyether polyols imparts particularly good hydrolysis properties to TPUs. If the intention is to have good mechanical properties, polyester polyols are advantageous.

Polyester polyols for TPUs are prepared, for example, from dicarboxylic acids having 2 to 12 carbon atoms, preferably 4 to 6 carbon atoms, and polyfunctional alcohols, such as glycols having 2 to 10 carbon atoms, polyester molecular weights of from 500 to 5,000 being employed as standard. As is described in EP 175 76 32 A2 also for TPUs from polyester polyols, TPUs which deliver particularly homogeneous shaped articles with a particularly good stability are obtained by means of a particular metering sequence of the monomers.

WO 2008/104541 A describes the reaction of succinic acid, which is produced biologically from carbohydrates by fermentation, with at least difunctional alcohols to give polyester alcohols. Difunctional alcohols which are chosen are monoethylene glycol, diethylene glycol,. monopropylene glycol, dipropylene glycol, 1,4-butanediol, 1,5-pentanediol, 1,6-hexanediol, 2-methyl-1,3-propanediol, 3-methyl-1,5-pentanediol, neopentyl glycol, glycerol, trimethylpropanediol, pentaerythritol and sorbitol. Polyester alcohols based on 1,3-propanediol are not mentioned and no restrictions or preferred ranges are mentioned for the molecular weight of the polyester alcohols. TPUs prepared from these polyester alcohols are also claimed. In the examples, polyesters of succinic acid, adipic acid and ethylene glycol and butanediol with molecular weights of approx. 1,900 are described and are reacted to give TPUs which have no particular properties and average mechanical values. No improvements of mechanical values are found and the tear propagation resistance is even slightly reduced.

### BRIEF SUMMARY OF THE INVENTION

The object of the present invention was to provide TPUs which have improved mechanical properties, such as e.g. 100% modulus (ISO 527-1,-3) or tear propagation resistance (ISO 34-1), and can be prepared completely or partly from biologically producible components.

It has been possible to achieve this object, surprisingly, in one embodiment, by
a thermoplastically processable polyurethane elastomer having a hardness of 50 Shore A to 70 Shore D (ISO 868), which are obtained from reacting components comprising
a) one or more linear polyester diols having a functionality from 1.8 to 2.2, wherein the one or more linear polyester diols comprise succinic acid 1,3-propionate and have an average molecular weight from 1,950 to 4,000 g/mol.
b) one or more organic diisocyanates,
c) one or more diols having a molecular weight from 60 to 350 g/mol,
wherein the components have a molar NCO:OH ratio of from 0.9:1 to 1.1:1.

Yet another embodiment of the present invention is a thermoplastically processable polyurethane elastomer having a hardness of 50 Shore A to 70 Shore D (ISO 868), which is obtained from components comprising
a) one or more linear polyester diols having a functionality from 1.8 to 2.2 and an average molecular weight from 2,000 to 3,500 g/mol, wherein the one or more linear polyester diols comprises succinic acid 1,3-propionate which is built up from 1,3-propanediol, succinic acid, or mixtures thereof and is produced biologically from carbohydrates by fermentation,
b) one or more organic diisocyanates selected from the group consisting of 4,4′-diphenylmethane-diisocyanate, isophorone-diisocyanate, dicyclohexylmethane-4,4-diisocyanate, 1,6-hexamethylene-diisocyanate, 1,5-naphthylene-diisocyanate, and mixtures thereof,
c) one or more chain lengthening diols selected from the group consisting of 1,4-butanediol, 1,3-propanediol, 1,2-ethylene glycol, 1,6-hexanediol, 1,4-di(β-hydroxyethyl)-hydroquinone, and mixtures thereof,
wherein the components have a molar NCO:OH ratio of from 0.9:1 to 1.1:1.

Yet another embodiment of the present invention is a process for producing the above thermoplastically processable polyurethane elastomer, which comprises
A) reacting one or more linear polyester diols having a functionality from 1.8 to 2.2, wherein the one or more linear polyester diols comprise succinic acid 1,3-propionate and have an average molecular weight from 1,950 to 4,000 g/mol, with a first portion of one or more organic diisocyanate(s) in a molar NCO:OH ratio of from 1.1:1 to 3.5:1, to form a higher weight isocyanate-terminated prepolymer,
B) mixing the higher weight isocyanate-terminated prepolymer formed in A with a second portion of one or more organic diisocyanate(s), wherein the total of the first and second portion of organic diisocyanate(s) is the total amount of diisocyanates used, and
C) reacting the mixture prepared in B) with one or more diols having a molecular weight from 60 to 350 g/mol.

### DETAILED DESCRIPTION OF THE INVENTION

“Molar NCO:OH” ratio here designates the ratio of isocyanate groups b) to the hydroxyl groups from a) and c) which are reactive towards isocyanate groups.

The expression “average molecular weight” here and in the following relates to the number-average molecular weight M̅ₙ.

Possible organic diisocyanates b) are, for example, aliphatic, cycloaliphatic, araliphatic, heterocyclic and aromatic diisocyanates, such as are described e.g. in Justus Liebigs Annalen der Chemie, 562, pages 75 to 136.

There may be mentioned specifically by way of example: aliphatic diisocyanates, such as hexamethylene-diisocyanate, cycloaliphatic diisocyanates, such as isophorone-diisocyanate, 1,4-cyclohexane-diisocyanate, 1-methyl-2,4-cyclohexane-diisocyanate and 1-methyl-2,6-cyclohexane-diisocyanate and the corresponding isomer mixtures, 4,4′-dicyclohexylmethane-diisocyanate, 2,4′-dicyclohexylmethane-diisocyanate and 2,2′-dicyclohexylmethane-diisocyanate and the corresponding isomer mixtures, aromatic diisocyanates, such as 2,4-toluylene-diisocyanate, mixtures of 2,4-toluylene-diisocyanate and 2,6-toluylene-diisocyanate, 4,4′-diphenylmethane-diisocyanate, 2,4′-diphenylmethane-diisocyanate and 2,2′-diphenylmethane-diisocyanate, mixtures of 2,4′-diphenylmethane-diisocyanate and 4,4′-diphenylmethane-diisocyanate, urethane-modified liquid 4,4′-diphenylmethane-diisocyanates or 2,4′-diphenylmethane-diisocyanates, 4,4′-diisocyanato-1,2-diphenylethane and 1,5-naphthylene-diisocyanate. 1,6-Hexamethylene-diisocyanate, 1,4-cyclohexane-diisocyanate, isophorone-diisocyanate, dicyclohexylmethane-diisocyanate, diphenylmethane-diisocyanate isomer mixtures having a 4,4′-diphenylmethane-diisocyanate content of more than 96 wt. %, 4,4′-diphenylmethane-diisocyanate and 1,5-naphthylene-diisocyanate are preferably used. The diisocyanates mentioned can be used individually or in the form of mixtures with one another. They can also be used together with up to 15 mol % (calculated for total diisocyanate) of a polyisocyanate, but polyisocyanate should be added at most in an amount such that a product which is still thermoplastically processable is formed. Examples of polyisocyanates are triphenylmethane-4,4′,4″-triisocyanate and polyphenyl-polymethylene-polyisocyanates.

Linear polyester diols are employed as polyols. These often contain small amounts of non-linear compounds due to the production. “Substantially linear polyols” are therefore also often referred to.

Polyester diols or also mixtures of several polyester diols a) to be employed according to the invention are built up to the extent of 40-100 wt. %, preferably to the extent of 90-100 wt. % from succinic acid and 1,3-propanediol, the wt. % data relating to the total weight of the polyester diols employed.

The polyester diols can be prepared, for example, from dicarboxylic acids having 2 to 12 carbon atoms, preferably 4 to 6 carbon atoms, and polyfunctional alcohols. Possible dicarboxylic acids are, for example: aliphatic dicarboxylic acids, such as succinic acid, glutaric acid, adipic acid, suberic acid, azelaic acid and sebacic acid, or aromatic dicarboxylic acids, such as phthalic acid, isophthalic acid and terephthalic acid. The dicarboxylic acids can be used individually or as mixtures, e.g. in the form of a succinic, glutaric and adipic acid mixture. For preparation of the polyester diols, it may possibly be advantageous to use the corresponding dicarboxylic acid derivatives instead of the dicarboxylic acids, such as carboxylic acid diesters having 1 to 4 carbon atoms in the alcohol radical, for example dimethyl terephthalate or dimethyl adipate, carboxylic acid anhydrides, for example succinic anhydride, glutaric anhydride or phthalic anhydride, or carboxylic acid chlorides. Examples of polyfunctional alcohols are glycols having 2 to 10, preferably 2 to 6 carbon atoms, e.g. ethylene glycol, diethylene glycol, 1,4-butanediol, 1,5-pentanediol, 1,6-hexanediol, 1,10-decanediol, 2,2-dimethyl-1,3-propanediol, 1,3-propanediol, 2-methyl-1,3-propanediol, 3-methyl-1,5-pentanediol or dipropylene glycol.

In addition, small amount of up to 3 wt. % of the total reaction mixture of low molecular weight polyols of higher functionality, such as e.g. 1,1,1-trimethylolpropane or pentaerythritol, can also be co-used.

The use of exclusively bifunctional starting compounds is preferred.

It may also happen, for example if dimethyl esters of the dicarboxylic acids are employed, that as a result of a not quite complete transesterification small amounts of unreacted methyl ester end groups reduce the functionality of the polyeSters to below 2.0, for example to 1.95 or also to 1.90.

The polycondensation is carried out by the routes known to the person skilled in the art, for example by driving out the water of reaction at temperatures of from 150 to 270° C. initially under normal pressure or slightly reduced pressure, and later lowering the pressure slowly, e.g. to 5 to 20 mbar. A catalyst is in principle not necessary, but usually very helpful. For example, tin(II) salts, titanium(IV) compounds, bismuth(III) salts and others are possible for this.

It may furthermore be advantageous to use an inert entraining gas, such as e.g. nitrogen, to drive out the water of reaction. In addition, methods in which an entraining agent which is liquid at room temperature, for example toluene, is employed in an azeotropic esterification can also be used.

Usually only one essentially linear polyester diol is employed for synthesis of the TPUs. However, mixtures of more than one essentially linear polyester diol can also be used.

As above, the polyester diols, optionally the mixtures of several polyester diols, contain to the extent of 40-100 wt. %, preferably to the extent of 90-100 wt. %, based on all the polyester diols employed, of succinic acid 1,3-propionate. Succinic acid 1,3-propionate is built up from succinic acid and 1,3-propanediol.

Succinic acid can be prepared by a petrochemical route, for example employing maleic acid as a starting compound, or can originate from biological sources.

If biological sources are resorted to, carbohydrates which are converted by a microbacterial route into succinic acid by fermentation, such as is described, for example, in U.S. Pat. No. 5,869,301, are possible.

1,3-Propanediol can likewise be prepared by a petrochemical route, for example employing acrolein as a starting compound, or can originate from biological sources. Thus, for example, 1,3-propanediol is obtained on a large industrial scale at DuPont Tate & Lyle fermentatively from maize syrup.

Preferred polyester diols are prepared using at least 90 wt. % of bio-based succinic acid (based on the total weight of the carboxylic acid or succinic acid employed) and/or at least 90 wt. % of bio-based 1,3-propanediol (based on the total weight of the diol or propanediol employed).

According to the invention, the polyester diols have number-average molecular weights M̅ₙ of from 1,950 to 4,000 g/mol, preferably of 2,000-3,500 g/mol, particularly preferably of 2,100-3,000 g/mol and very particularly preferably of 2,200-2,900 g/mol.

Chain-lengthening agents which are employed are diols, optionally in a mixture with small amounts of diamines, with a molecular weight of from 60 to 350 g/mol, preferably aliphatic diols having 2 to 14 carbon atoms, such as e.g. ethanediol, 1,3-propanediol, 1,6-hexanediol, diethylene glycol, dipropylene glycol, ethylene glycol and, in particular, 1,4-butanediol. However, diesters of terephthalic acid with glycols having 2 to 4 carbon atoms, e.g. terephthalic acid bis-ethylene glycol or terephthalic acid bis-1,4-butanediol, hydroxyalkylene ethers of hydroquinone, e.g. 1,4-di(β-hydroxyethyl)-hydroquinone, ethoxylated bisphenols, e.g. 1,4-di(β-hydroxyethyl)-bisphenol A, are also suitable. Preferably, ethanediol, 1,3-propanediol, 1,4-butanediol, 1,6-hexanediol and 1,4-di(β-hydroxyethyl)-hydroquinone are used as chain lengtheners. Mixtures of the abovementioned chain lengtheners can also be employed. In addition, relatively small amounts of triols can also be added.

Small amounts of conventional monofunctional compounds, e.g. as chain terminators or mould release aids, can furthermore also be added. There may be mentioned by way of example alcohols, such as octanol and stearyl alcohol, or amines, such as butylamine and stearylamine.

For preparation of the TPUs, the builder component, optionally in the presence of catalysts, auxiliary substances and/or additives, can be reacted in amounts such that the ratio of equivalents of NCO groups to the sum of NCO-reactive groups is 0.9:1.0 to 1.1:1.0, preferably 0.95:1.0 to 1.10:1.0.

Suitable catalysts according to the invention are the tertiary amines which are known and conventional according to the prior art, such as e.g. triethylamine, dimethylcyclohexylamine, N-methylmorpholine, N,N′-dimethylpiperazine, 2-(dimethylaminoethoxy)ethanol, diazabicyclo[2,2,2]octane and similar compounds, and, in particular, organometallic compounds, such as titanic acid esters, iron compounds or tin compounds, such as tin diacetate, tin dioctoate, tin dilaurate or the tin-dialkyl salts of aliphatic carboxylic acids, such as dibutyltin diacetate or dibutyltin dilaurate or similar compounds. Preferred catalysts are organometallic compounds, in particular titanic acid esters and iron and tin compounds. The total amount of catalysts in the TPUs is as a rule about 0 to 5 wt. %, preferably 0 to 1 wt. %, based on the TPU.

In addition to the TPU components and the catalysts, auxiliary substances and/or additives can also be added. There may be mentioned by way of example lubricants, such as fatty acid esters, metal soaps thereof, fatty acid amides, fatty acid ester amides and silicon compounds, antiblocking agents, inhibitors, stabilizers against hydrolysis, light, heat and discoloration, flameproofmg agents, dyestuffs, pigments, inorganic and/or organic fillers and reinforcing agents. Reinforcing agents are, in particular, fibrous reinforcing substances, such as e.g. inorganic fibres, which are prepared according to the prior art and can also be charged with a size. Preferably, nanoparticulate solids, such as e.g. carbon black, can also be added to the TPUs in amounts of 0-10 wt. %. Further details on the auxiliary substances and additives mentioned are to be found in the technical literature, for example the monograph by J. H. Saunders and K. C. Frisch “High Polymers”, volume XVI, Polyurethane, part 1 and 2, Verlag Interscience Publishers 1962 and 1964, Taschenbuch für Kunststoff-Additive by R. Gächter and H. Mailer (Hanser Verlag Munich 1990) or DE-A 29 01 774.

Further additives which can be incorporated into the TPU are thermoplastics, for example polycarbonates and acrylonitrile/butadiene/styrene terpolymers, in particular ABS. Other elastomers, such as rubber, ethylene/vinyl acetate copolymers, styrene/butadiene copolymers and other TPUs, can also be used. Commercially available plasticizers, such as phosphates, phthalates, adipates, sebacates and alkylsulfonic acid esters, are furthermore suitable for incorporation.

The TPU may be prepared in one stage (simultaneous addition of the reaction components =one shot) or in several stages (e.g. prepolymer process or a process comprising soft segment pre-extension in accordance with EP 571 830).

In a preferred embodiment, the TPU is prepared in a several stage process comprising soft segment pre-extension, whereby in
stage A) of this process one or more linear polyester diols having a functionality from 1.8 to 2.2, wherein the one or more linear polyester diols comprise succinic acid 1,3-propionate and have an average molecular weight from 1,950 to 4,000 g/mol, are reacted with a part amount lof the organic diisocyanate(s) in a molar NCO:OH ratio of from 1.1:1 to 3.5:1, preferably from 1.3:1 to 2.5:1, to form a higher weight isocyanate-terminated prepolymer (“NCO prepolymer”),
Stage B) the NCO prepolymer formed in stage A is mixed with a part amount 2 of the organic diisocyanate(s), whereby the sum of part amounts 1 and 2 is equal to the total amount of diisocyanates used, and
stage C) the mixture prepared in stage B) is reacted with one or more diols having a molecular weight from 60 to 350 g/mol.

Preferably the one ore more diisocyanates of part amount 1 in stage A) are the same diisocyanates as of part amount 2 in stage B).

Independently of the process, the molar ratio of the NCO groups to the OH groups in total over all the stages is established at 0.9:1 to 1.1:1.

The known mixing units, preferably those which operate with a high shearing energy, are suitable for preparation of the TPUs. For continuous preparation there may be mentioned by way of example cokneaders, preferably extruders, such as e.g. twin-shaft extruders and Buss kneaders, or static mixers.

The TPUs according to the invention can be processed to injection moulded articles, e.g. functional parts on sports shoes, and to homogeneous extruded articles, in particular films.

They have improved mechanical values, such as e.g. an increased modulus in the tensile test and an improved tear propagation resistance.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

The invention is to be explained in more detail with the aid of the following examples.

### EXAMPELS

### A) Raw Materials Used:

PE 225 B butanediol adipate with a molecular weight of Mₙ=2,200 g/mol (BayerMaterialScience AG)

MDI diphenylmethane-4,4′-diisocyanate (BayerMaterialScience AG)

BUT 1,4-butanediol (BASF AG) 1,3-Propanediol, biobased (DuPont Tate & Lyle)

Succinic acid biobased, acid number: 946 mg of KOH/g corresp. to Mₙ=118.6 g/mol (Bioamber)

### B) Preparation of the Polyesters:

BSP 1100 succinic acid 1,3-propionate with a molecular weight of M̅ₙ=1,100 g/mol

BSP 2200 succinic acid 1,3-propionate with a molecular weight of M̅ₙ=2,200 g/mol

BSP 2900 succinic acid 1,3-propionate with a molecular weight of M̅ₙ=2,900 g/mol

### BSP 1100

2,421 g (20.41 mol) of biobased succinic acid and 1,817 g (23.87 mol) of 1,3-propanediol were initially introduced at room temperature, while covering with a blanket of nitrogen, into a 6 litre 4-necked flask equipped with a heating mushroom, mechanical stirrer, internal thermometer, 40 cm packed column, column head, descending intensive condenser and membrane vacuum pump and were heated slowly to 200° C., while stirring, water of reaction being distilled of from a temperature of approx. 140° C. After approx. 6 h, the reaction stopped. 70 mg of tin(II) chloride dihydrate were added, the pressure was reduced to 200 mbar in the course of approx. 2 h and the reaction was continued under these conditions for a further 16 hours. To bring the reaction to completion, the vacuum was reduced to 16 mbar for a further 4 h, the mixture was cooled and the following data were determined:

Analysis of the polyester BSP 1100: Hydroxyl number: 104.1 mg of KOH/g; acid number: 0.22 mg of KOH/g; viscosity: 11,800 mPas (25° C.), 1,470 mPas (50° C.), 405 mPas (75° C.)

### BMS 101099

The OH and acid numbers were determined as described in “Methoden der organischen Chemie (Houben-Weyl), Makromolekulare Stoffe, volume 14/2, p. 17, Georg Thieme Verlag, Stuttgart 1963.

The viscosities were determined with a Physica MCR 51 viscometer from Anton Paar, equipped with a CP-50-1 measuring cone, at shear rates of between 1 and 1,000/s.

BSP 2200 [b)] and BSP 2900 [c)] were prepared analogously to BSP 1100, the molar ratios of dicarboxylic acid to diol having been changed to establish the molecular weights of the polyester polyols.

### b) BSP 2200

Weight of 1,3-propanediol: 3,776 g (49.7 mol)

Weight of succinic acid: 5,437 g (45.8 mol)

Weight of tin(II) chloride dihydrate: 270 mg

Analysis of the polyester: Hydroxyl number: 51.4 mg of KOH/g; acid number: 0.4 mg of

KOH/g; viscosity: 1,660 mPas (75° C.)

### c) BSP 2900

Weight of 1,3-propanediol: 3,743 g (49.25 mol)

Weight of succinic acid: 5,493 g (46.32 mol)

Weight of tin(II) chloride dihydrate: 180 mg

Analysis of the polyester: Hydroxyl number: 38.9 mg of KOH/g; acid number: 0.9 mg of

KOH/g; viscosity: 3,210 mPas (75° C.)

### C. Preparation of the TPUs

In each case one polyol was initially introduced according to Table 1 into a reaction vessel. After heating up to 180° C., part amount 1 of the 4,4′-diphenylmethane-diisocyanate (MDI) was added, while stirring, and the prepolymer reaction was brought to a conversion of greater than 90 mol %, based on the polyol, with the aid of 50 ppm, based on the amount of polyol, of the catalyst tin dioctoate.

When the reaction had ended, part amount 2 of the MDI was added, while stirring. The amount of chain lengthener butanediol [BUT] stated in Table 1 was then added, the NCO/OH ratio of the components being 1.00. After intensive thorough mixing, the TPU reaction mixture was poured out on to a metal sheet and conditioned at 120° C. for 30 minutes.

TABLE 1

| | | Amount | MDI | MDI | |
|---|---|---|---|---|---|
| | | of polyol | part amount | part amount | BUT |
| Example | Polyol | [mol] | 1 [mol] | 2 [mol] | [mol] |
| 1 | BSP2200 | 1 | 2.78 | 0.94 | 3.72 |
| 2* | PE 225 B | 1 | 2.78 | 0.94 | 3.72 |
| 3 | BSP2200 | 1 | 2.85 | 1.50 | 4.35 |
| 4* | BSP1100 | 1 | 2.78 | 0.06 | 1.88 |
| 5* | PE 225 B | 1 | 2.85 | 1.50 | 4.35 |
| 6 | BSP2200 | 1 | 3.23 | 3.07 | 6.30 |
| 7* | PE 225 B | 1 | 3.23 | 3.07 | 6.30 |
| 8 | BSP2200 | 1 | 3.51 | 3.87 | 7.38 |
| 9* | PE 225 B | 1 | 3.51 | 3.87 | 7.38 |
| 10 | BSP2900 | 1 | 2.00 | 3.41 | 5.41 |

*comparison example which is not according to the invention

The cast sheets were cut and granulated. The granules were melted in an Allrounder 470 S (30-screw) injection moulding machine from Arburg and formed into S1 bars (mould temperature: 25° C.; bar size: 115×25/6×2), sheets (mould temperature: 25° C.; size: 125×50×2 mm) or round plugs (mould temperature: 25° C.; diameter 30 mm, thickness 6 mm).

### Measurements

Measurement of the hardness was carried out in accordance with ISO 868; the measurements in the tensile test according to ISO 527-1,-3 gave the 100% modulus, tear strength and elongation; the tear propagation resistance was measured in accordance with ISO 34-1.

The solidification speed directly after the injection moulding was measured as the initial hardness by a hardness measurement on the round plug directly after removal from the mould (approx. 3 sec).

The higher this value, the higher the solidification speed and the shorter the cycle time during the injection moulding.

The measurement values are shown in Table 2:

| | | | | | | Tear | Initial |
|---|---|---|---|---|---|---|---|
| | | | | | Elonga- | propa- | hard- |
| | Hard- | Hard- | | | tion | gation | ness |
| | ness | ness | 100% | Tear | at | resist- | after |
| Ex- | Shore | Shore | modulus | strength | break | ance | inj. m. |
| ample | A | D | MPa | MPa | % | N/mm | Shore A |
| 1 | 91 | 43 | 10.1 | 48 | 499 | 94 | 56 |
| 2* | 91 | 42 | 8.0 | 54 | 477 | 88 | 69 |
| 3 | 93 | 47 | 13.2 | 57 | 483 | 124 | 72 |
| 4* | 91 | 48 | 13.2 | 40 | 476 | 116 | 13 |
| 5* | 93 | 45 | 9.3 | 58 | 471 | 94 | 78 |
| 6 | 97 | 58 | 24.0 | 45 | 331 | 153 | 88 |
| 7* | 97 | 55 | 17.8 | 47 | 302 | 125 | 90 |
| 8 | 98 | 64 | 28.1 | 42 | 275 | 175 | |
| 9* | 98 | 61 | 22.1 | 46 | 274 | 152 | |
| 10 | 94 | 50 | 10.0 | 50 | 637 | 96 | 87 |

*comparison example which is not according to the invention

Compared with the conventional TPUs based on PE 225 B, the TPUs according to the invention based on succinic acid 1,3-propionate (molecular weight 2,200) have, in the same recipe, significantly improved 100% moduli and tear propagation resistances (Examples 1-2; 3-5; 6-7; 8-9).

At the same 100% modulus, the TPU based on the polyester of molecular weight 2,900 has a solidification speed which is improved further (Examples 1 and 10), while the comparison TPU based on the polyester which is not according to the invention and has the molecular weight of 1,100 has a significantly poorer solidification speed (Examples 3 and 4*).

1. A thermoplastically processable polyurethane elastomer having a hardness of 50 Shore A to 70 Shore D (ISO 868), which is obtained from reacting components comprising
a) one or more linear polyester diols having a functionality from 1.8 to 2.2, wherein the one or more linear polyester diols comprise succinic acid 1,3-propionate and have an average molecular weight from 1,950 to 4,000 g/mol,
b) one or more organic diisocyanates,
c) one or more chain lengthening diols having a molecular weight from 60 to 350 g/mol,
wherein the components have a molar NCO:OH ratio of from 0.9:1 to 1.1:1.

2. The thermoplastically processable polyurethane elastomer according to claim 1, wherein the one or more linear polyester diols have an average molecular weight from 2,000 to 3,500 g/mol.

3. The thermoplastically processable polyurethane elastomer according to claim 1, wherein at least one of the components a) and c) are produced at least partly biologically.

4. The thermoplastically processable polyurethane elastomer according to claim 3, wherein at least one of the components a) and c) are produced completely biologically.

5. The thermoplastically processable polyurethane elastomer according to claim 1, wherein the one or more organic diisocyanates are selected from the group consisting of 4,4′-diphenylmethane-diisocyanate, isophorone-diisocyanate, dicyclohexylmethane-4,4-diisocyanate, 1,6-hexamethylene-diisocyanate, 1,5-naphthylene-diisocyanate, and mixtures thereof.

6. The thermoplastically processable polyurethane elastomer according to claim 1, wherein the one or more chain lengthening diols is selected from the group consisting of 1,4-butanediol, 1,3-propanediol, 1,2-ethylene glycol, 1,6-hexanediol, 1,4-di(β-hydroxyethyl)-hydroquinone, and mixtures thereof.

7. The thermoplastically processable polyurethane elastomer according to claim 1, wherein the succinic acid 1,3-propionate is built up from succinic acid produced biologically from carbohydrates by fermentation.

8. The thermoplastically processable polyurethane elastomer according to claim 1, wherein the succinic acid 1,3-propionate is built up from 1,3-propanediol produced biologically from carbohydrates by fermentation.

9. The thermoplastically processable polyurethane elastomer according to claim 1, wherein the one or more chain lengthening diols comprises a biologically produced 1,3-propanediol.

10. A thermoplastically processable polyurethane elastomer having a hardness of 50 Shore A to 70 Shore D (ISO 868), which is obtained from components comprising
a) one or more linear polyester diols having a functionality from 1.8 to 2.2 and an average molecular weight from 2,000 to 3,500 g/mol, wherein the one or more linear polyester diols comprises succinic acid 1,3-propionate which is built up from 1,3-propanediol, succinic acid, or mixtures thereof and is produced biologically from carbohydrates by fermentation,
b) one or more organic diisocyanates selected from the group consisting of 4,4′-diphenylmethane-diisocyanate, isophorone-diisocyanate, dicyclohexylmethane-4,4-diisocyanate, 1,6-hexamethylene-diisocyanate, 1,5-naphthylene-diisocyanate, and mixtures thereof,
c) one or more chain lengthening diols selected from the group consisting of 1,4-butanediol, 1,3-propanediol, 1,2-ethylene glycol, 1,6-hexanediol, 1,4-di(β-hydroxyethyl)-hydroquinone, and mixtures thereof,
wherein the components have a molar NCO:OH ratio of from 0.9:1 to 1.1:1.

11. A process for producing a thermoplastically processable polyurethane elastomer according to claim 1, which comprises
A) reacting the one or more linear polyester diols with a first portion of the one or more organic diisocyanate(s) in a molar NCO:OH ratio of from 1.1:1 to 3.5:1, to form a higher weight isocyanate-terminated prepolymer,
B) mixing the higher weight isocyanate-terminated prepolymer formed in A with a second portion of the one or more organic diisocyanate(s), wherein the total of the first and second portion of the organic diisocyanate(s) is the total amount of diisocyanates used, and
C) reacting the mixture prepared in B) with the one or more chain lengthening diols.

12. The process according to claim 11, wherein the same one or more organic diisocyanate(s) are used in A) and B).

13. The process according to claim 11, wherein the NCO:OH ratio is from 1.3:1 to 2.5:1 in A).

14. A process for producing a thermoplastically processable polyurethane elastomer according to claim 10, which comprises
A) reacting the one or more linear polyester diols with a first portion of the one or more organic diisocyanate(s) in a molar NCO:OH ratio of from 1.1:1 to 3.5:1, to form a higher weight isocyanate-teoninated prepolymer,
B) mixing the higher weight isocyanate-terminated prepolymer formed in A with a second portion of the one or more organic diisocyanate(s), wherein the total of the first and second portion of the organic diisocyanate(s) is the total amount of diisocyanates used, and
C) reacting the mixture prepared in B) with the one or more chain lengthening diols.

15. The process according to claim 14, wherein the same one or more organic diisocyante(s) are used in A) and B).

16. The process according to claim 14, wherein the NCO:OH ratio is from 1.3:1 to 2.5:1 in A).
